(19) United States
(12) Patent Application Publication
(10) Pub. No.: US 2009/0260396 A1
(43) Pub. Date: Oct. 22, 2009

(54) METHODS FOR PROCESSING ORNAMENTAL DIAMONDS AND CORRESPONDING ORNAMENTAL DIAMONDS

(76) Inventors: Eitan Broukman, Tel Aviv (IL); Yoel Shor, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/103,774

(22) Filed: Apr. 16, 2008

(51) Int. Cl. A44C 17/00; B24B 1/00; B26D 3/00; B26D 7/00

(52) U.S. Cl. 63/32; 451/41; 83/39; 83/13

(57) ABSTRACT

A method for processing diamonds and corresponding ornamental diamond structures employ diamonds having visible cloud inclusions. The diamond is cut and polished to form crown and pavilion facets angled so as to form a light transmission window over a readily noticeable portion of an area of the diamond. This renders a geometrical form of the cloud inclusion readily visible to the unaided human eye. Preferably, a major part of the light transmission window is formed by a primary table facet of the crown and a primary base facet of the pavilion angled which are roughly parallel to each other.

### FIELD AND BACKGROUND OF THE INVENTION

The present invention relates to ornamental diamonds and, in particular, it concerns a method of processing diamonds having internal cloud inclusions and a corresponding ornamental diamond produced by such methods.

The ornamental diamond trade has highly standardized criteria for classifying and valuing cut ornamental diamonds. These criteria are informally referred to as “the four C's”: carat (weight); cut; clarity; and color.

While there exist a wide variety of diamond cuts, having different shapes and differing numbers of facets, each cut attempts to provide high “light performance”, i.e., maximizing the amount of incoming light which undergoes total internal reflection and is reflected back to reach the eye of the viewer. To this end, diamond cuts all share a pavilion shape approximating to the “brilliant” cut calculated by Marcel Tolkowsky illustrated in FIGS. 1A and 1B, or variants or modifications thereof. These cuts either have a pavilion terminating at a pointed culet (FIG. 1A), or have a very small culet facet (FIG. 1B) in order to reduce the risk of damage to the point. Use of a larger culet facet is avoided since it would allow the escape of light from the bottom of the diamond, thereby reducing the light performance and value of the stone. Any culet facet visible to the naked eye is considered a negative consideration in the quality of the cut.

The parameters of a “brilliant” pavilion are highly standardized, as illustrated in FIGS. 2A-2C. The correct pavilion angle of FIG. 2B (about 41° to the plane of the girdle) ensures total internal reflection of light from above, leading to the sought after high light performance. Too high an inclination (i.e., too deep a pavilion) leads to escape of light as illustrated in FIG. 2A, while too small an angle (i.e., too shallow a pavilion) also leads to escape of light as shown in FIG. 2C. Any case in which light from above can escape through the bottom of the stone is considered a serious shortcoming of the cut.

With regard to clarity of a diamond, it is common for diamonds to have various types of natural inclusions, i.e., impurities or structural imperfections which affect the optical properties of the diamond. One type of inclusion is a “cloud inclusion” in which the optical properties are impacted over a three-dimensional region within the diamond which may absorb light, rending that region dark. In cases of relatively slight inclusions, after cutting the diamond into a brilliant cut, the multiple internal reflections of all light paths within the diamond render the cloud inclusion unnoticeable to the naked eye, and may not significantly impact the light performance of the stone. In more severe cases, the cloud inclusion may seriously impact the light performance of the stone, rendering the entire diamond dark. Such stones are clearly of greatly reduced value in the ornamental diamond market compared to otherwise comparable stones of greater clarity.

There is therefore a need for a method of processing diamonds having internal cloud inclusions and a corresponding ornamental diamond produced by such methods.

### SUMMARY OF THE INVENTION

The present invention is a method of processing diamonds having internal cloud inclusions and a corresponding ornamental diamond produced by such methods.

According to the teachings of the present invention there is provided, a method for processing diamonds comprising the steps of: (a) selecting a diamond having a visible cloud inclusion; and (b) cutting and polishing the diamond to form a table and a major base facet substantially parallel to the table, thereby rendering a geometrical form of the cloud inclusion readily visible to the unaided human eye.

There is also provided, according to the teachings of the present invention, an ornamental diamond formed from a natural diamond having a visible cloud inclusion, the diamond being cut and polished to exhibit: (a) a table; and (b) a major base facet substantially parallel to, and in facing relation to, the table, the major base facet having an area greater than half the area of the table, thereby rendering a geometrical form of the cloud inclusion readily visible to the unaided human eye.

There is also provided, according to the teachings of the present invention, a pair of ornamental diamonds each as described above, wherein the pair of ornamental diamonds include a pair of cloud inclusions providing similar geometrical forms generated by cutting a single raw unpolished diamond on a plane subdividing a cloud inclusion.

According to a further feature of the present invention, the major base facet has an area greater than half the area of the table.

According to a further feature of the present invention, the table has an area greater than a fifth of the area enclosed by a cut girdle of the diamond.

According to a further feature of the present invention, a plane of the table is chosen relative to a shape of the cloud inclusion to render the geometrical form generally symmetrical as viewed through the table.

According to a further feature of the present invention, the cutting and polishing is performed so as to render the geometrical form substantially centered relative to a cut girdle of the diamond.

According to a further feature of the present invention, the geometrical form corresponds to a cross, and wherein the cutting and polishing is performed so as to render the center of the cross substantially centered relative to a cut girdle of the diamond.

According to a further feature of the present invention, the table corresponds to a four-corner-cut plane.

According to a further feature of the present invention, the cutting includes: (a) dividing the diamond prior to polishing along a plane passing through the visible cloud inclusion so as to produce two smaller diamonds each including part of the visible cloud inclusion; and (b) cutting and polishing each of the two smaller diamonds to form a table and a major base facet substantially parallel to the table.

According to a farther feature of the present invention, the cutting includes: (a) dividing the diamond prior to polishing along at least two planes passing through the visible cloud inclusion so as to produce at least three smaller diamonds each including part of the visible cloud inclusion; and (b) cutting and polishing each of the at least three smaller diamonds to form a table and a major base facet substantially parallel to the table.

There is also provided according to the teachings of the present invention, a method of processing a plurality of diamonds comprising the steps of: (a) selecting diamonds having a cloud enclosure; (b) cutting the diamonds to form a table; (c) sorting to identify cloud enclosures having one or more desired geometrical form; and (d) cutting and polishing diamonds having the desired geometrical form to form a major base facet substantially parallel to the table, thereby rendering the geometrical form of the cloud inclusion readily visible to the unaided human eye.

According to a further feature of the present invention, the diamonds not having the desired geometrical form are cut and polished according to a brilliant cut.

There is also provided according to the teachings of the present invention, a method for processing diamonds comprising the steps of: (a) selecting a diamond having a visible cloud inclusion; (b) cutting and polishing the diamond to form at least one crown facet and at least one pavilion facet, the crown and pavilion facets being angled so as to form a light transmission window over a readily noticeable portion of an area of the diamond, thereby rendering a geometrical form of the cloud inclusion readily visible to the unaided human eye.

According to a further feature of the present invention, a major part of the light transmission window is formed by a primary table facet of the crown and a primary base facet of the pavilion angled relative to the primary table facet at an angle of no more than about 20 degrees.

According to a further feature of the present invention, a major part of the light transmission window is formed by a primary table facet of the crown and a primary base facet of the pavilion substantially parallel to the primary table facet.

### BRIEF DESCRIPTION OF THE DRAWINGS

The patent or application file contains at least one drawing executed in color. Copies of this patent or patent application publication with color drawings will be provided by the Office upon request and payment of the necessary fee.

The invention is herein described, by way of example only, with reference to the accompanying drawings, wherein:

FIGS. 1A and 1B are schematic side views, described above, of a conventional brilliant cut diamond without and with a culet facet, respectively;

FIGS. 2A-2C are schematic side views, described above, illustrating correct and incorrect pavilion geometries according to a conventional brilliant cut;

FIGS. 3A and 3B are schematic side and top views of an ornamental diamond with a cloud inclusion, cut and formed according to the teachings of the present invention;

FIGS. 4A and 4B are schematic representations of steps during the cutting of an ornamental diamond with a cloud inclusion according to the teachings of the present invention.

FIGS. 5A and 5B are color photographs illustrating a given diamond with a cloud inclusion, the diamond being shown in an intermediate state with a complete pointed pavilion and in a final state with a truncated pavilion to form a major base facet according to the teachings of the present invention;

FIGS. 6A and 6B are color photographs showing top views of the diamond of FIGS. 5A and 5B, respectively;

FIG. 7 is a color photograph illustrating a preferred orientation of sawing an octahedral raw diamond according to the teachings of the present invention; and

FIG. 8 is a color photograph illustrating a preferred orientation of sawing an irregular raw diamond according to the teachings of the present invention.

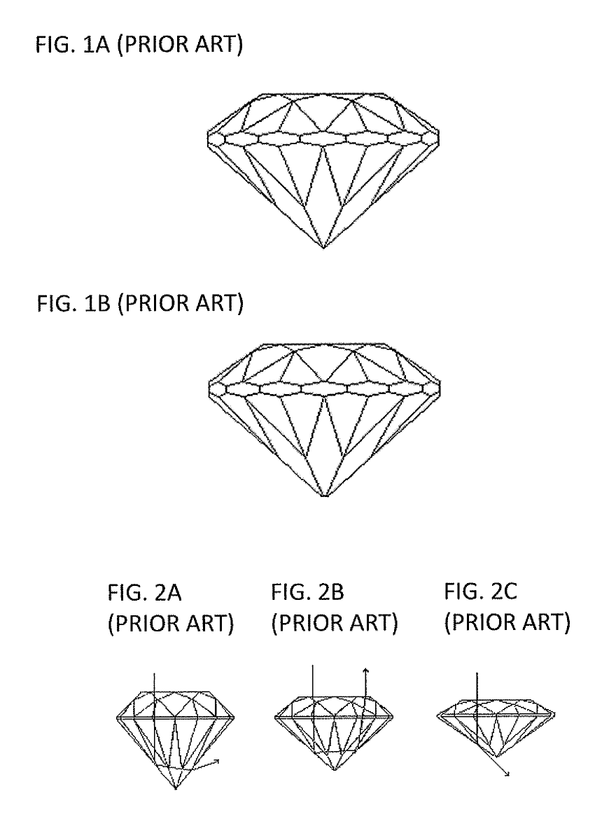

### DESCRIPTION OF THE PREFERRED EMBODIMENTS

The present invention is a method of processing diamonds having internal cloud inclusions and a corresponding ornamental diamond produced by such methods.

The principles and operation of methods and corresponding diamonds according to the present invention may be better understood with reference to the drawings and the accompanying description.

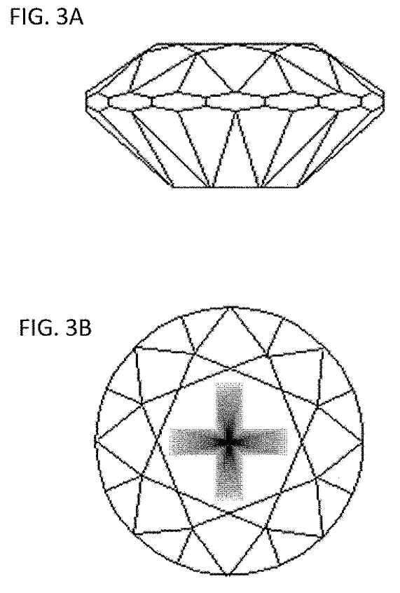

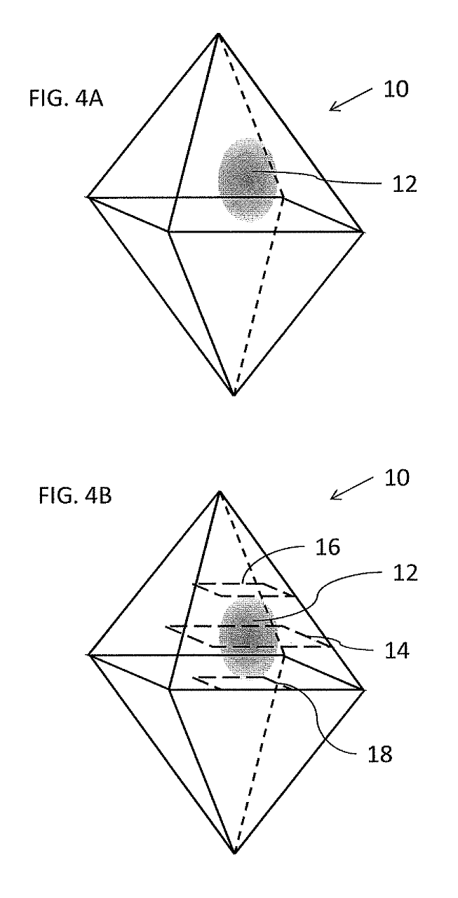

Referring now to the drawings, FIGS. 3A, 3B, 5B and 6B illustrate ornamental diamonds constructed and operative according to the teachings of the present invention, while FIGS. 4A, 4B, 5A, 6A, 7 and 8 illustrate various steps during implementation of a method of processing diamonds according to the teachings of the present invention and/or illustrate the significance of certain aspects of the present invention.

In general terms, a method for processing diamonds according to the present invention includes selecting a diamond having a visible cloud inclusion and cutting and polishing the diamond in order to render a geometrical form of the cloud inclusion readily visible to the unaided human eye. In practical terms, this is done by forming at least one crown facet and at least one pavilion facet, the crown and pavilion facets being angled so as to form a light transmission window over a readily noticeable portion of an area of the diamond, thereby rendering the geometrical form of the cloud inclusion readily visible to the unaided human eye. According to one set of particularly preferred implementations, a major part of the light transmission window is formed by a primary table facet of the crown and a primary base facet of the pavilion angled relative to each other at an angle of no more than about 20 degrees, and most preferably substantially parallel.

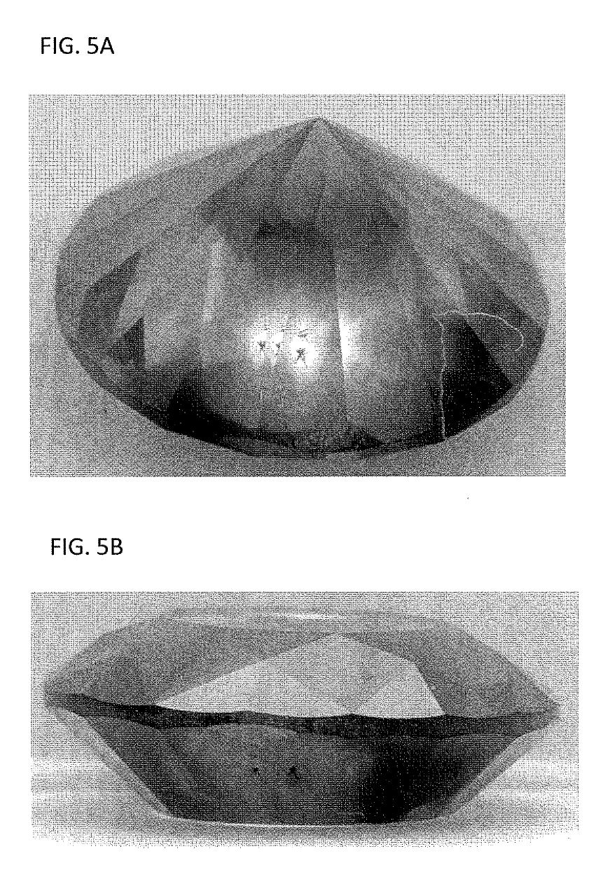

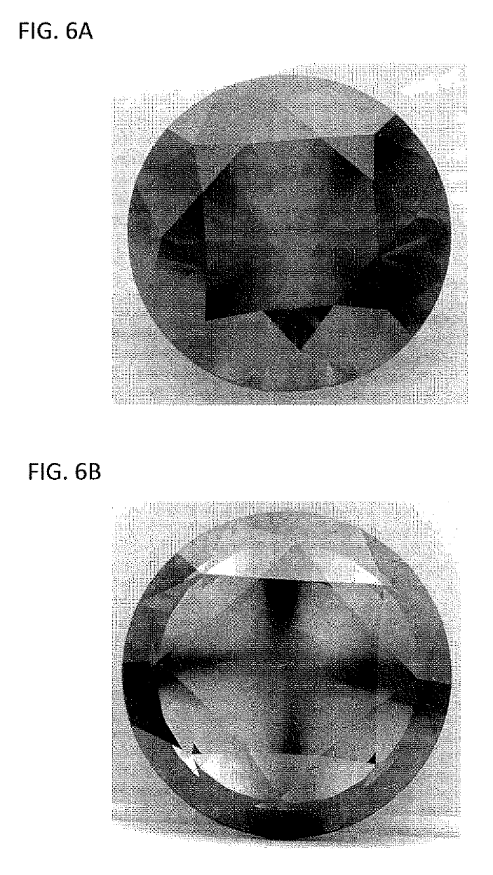

An example of the effect of this method can be appreciated by comparing FIGS. 6A and 6B. FIG. 6A shows a diamond having a visible cloud inclusion cut with a brilliant-type pavilion as seen in FIG. 5A. In this state, the multiple internal reflections of the pavilion prevent the transmission of light through the stone from top to bottom and render the geometric form of the cloud insertion difficult if not impossible to see. In clear contrast, when the pavilion is further cut to form a major base facet parallel to the table of the stone (as visible in FIG. 5B), a large light transmission window is formed, thereby clearly revealing a geometrical form of the cloud inclusion as seen in FIG. 6B.

It should be appreciated that the above described method is antithetical to the universally applied teachings of the diamond industry. The method takes a diamond which may be considered medium to poor quality in terms of clarity and color, and applies to it a cut which generates a large light transmission window, thus destroying all hope of achieving the distinctive brilliance for which diamonds are traditionally prized, as well as reducing the carat yield. By doing so, the invention reveals hitherto unrecognized beauty of geometrical patterns which can be found in certain cloud inclusions, such that each diamond becomes a distinctively unique ornamental diamond. These and other advantages of the present invention will be better understood from the following detailed description and drawings.

Before addressing the features of the present invention in more detail, it will be useful to define certain terminology as used herein in the description and claims. Firstly, the invention as described herein is specific to diamonds. Particularly within the field of diamonds, conventions for cutting are highly standardized and do not allow for deviations, particularly with respect to overall shape of the pavilion. The word “stone” is used herein interchangeably with the word “diamond” without implying any extension in the scope of the description.

The invention is referred to as relating to “ornamental diamonds” in the sense that the primary function of the diamond relates to its appearance, either for free-standing display or as part of an article of jewelry. It should be noted that the term “ornamental” is used herein in contrast to “industrial” or otherwise intended for performing a mechanical function. Also included are diamonds to which an individual may attribute metaphysical or other non-mechanical properties (for example, kept as a “charm”), even if not intended primarily for display to others.

The invention is applicable to all sizes of diamonds, although the desired visual effect is typically more striking in diamonds in excess of 1 carat. It should be noted, as will be detailed further below, that the methods of the present invention, and the final product, typically result in lower, and sometimes dramatically lower, carat yield than would be achieved by conventional techniques. It is believed, however, that the added value of the resulting product will outweigh the normal considerations of carat weight.

The phrase “visible cloud inclusion” is used to refer to any inclusion within a diamond which extends through a three-dimensional volume of the diamond and which absorbs or scatters light of at least one visible wavelength, thereby rendering the inclusion “visible”. It should be noted that the term “visible” is used in is context to describe the intrinsic properties of the inclusion which render it suitable for implementing the present invention, and does not indicate how easily the inclusion can actually be seen. In fact, in the raw state of a diamond, the presence of an inclusion is often difficult to detect, but may be seen by one ordinarily skilled in the art by use of strong back lighting and/or by opening a small polished surface through the “skin” of the diamond to facilitate inspection.

The invention is applicable for inclusions ranging from slight inclusions which would have negligible effect on the clarity of a final product cut according to a “brilliant” cut, through to heavy inclusions which would severely impact the light performance of a brilliant cut. The inclusion may be colored or may be black or gray (color neutral) in its optical effects. The inclusion may occur in diamonds having a wide range of color grades.

Of particular importance for implementing the present invention are cloud inclusions which exhibit, or can be cut to render them into, geometrical forms which are of aesthetic interest, or of associative interest, i.e., of interest due to their symbolism or other association with a religion, country or other social or cultural group. Naturally occurring cloud inclusions vary widely in shape and distribution within the diamond and, if cut appropriately, allow formation of a range of different geometrical forms. Examples include, but are not limited to, a cross, a crescent, a star of David, other star shapes, a pattern of three triangles meeting at a point, a maple leaf shape and other symmetrical or asymmetrical shapes of interest. The example of a cross-shape has been found to be particularly straightforward to achieve in certain cases due to a common occurrence of four-fold symmetry in the four-point plane of the natural octahedral crystal form of diamonds. A pattern of three triangles meeting at a point can often be achieved by cleaving a diamond through the cloud inclusion along a three-point plane.

It will be noted that the geometrical forms are typically defined by contrast variations between different regions of the cloud inclusion, and vary considerably in sharpness and contrast. In certain cases, particularly where the contrast is initially not pronounced, the cut of the stone may be chosen in order to enhance the contrast, for example, by thinning the stone or by cutting away a specific region with problematically low contrast.

The terms “cutting” and “polishing” are used to refer to any and all processes used for shaping and polishing a diamond according to any available technology, and include amongst others sawing and cleaving. The terms “girdle”, “crown”, and “pavilion” are used in their normal senses, so that the “girdle” refers to the outermost outline of the stone, the “crown” refers to all facets lying above the girdle, and the “pavilion” refers to all facets lying below the girdle. Use of the words “crown” and “pavilion” do not in any way imply the presence of any conventional crown or pavilion cut. Where reference is made to the “area” of a diamond, this refers to the total area of a plane enclosed by the outline of the girdle.

Reference is made herein to a “light transmission window” formed by the cut of a diamond. The phrase “light transmission window” is used herein to refer to a geometry of surfaces which allows transmission of normally incident light from above through the base of the diamond. This is an effect which is considered highly undesirable by conventional diamond cutting standards, and if present at all, is normally limited to a tiny culet facet which is invisible or nearly invisible to the naked eye. In contrast, the present invention forms a light transmission wind which extends over a readily noticeable portion of the area of the diamond, and in many cases over a major portion of the area. The extent to which this cut is against the conventional standards may be illustrated by applying standard industry-approved cut analysis software to generate a report regarding the quality of the cut. When applied to diamonds cut according to the teachings of the present invention, the software generates “out of range” errors for the pavilion geometry and indicates that the diamond should be re-cut.

For the purpose of these definitions, the phrase “a readily noticeable portion” may be taken to refer to a region extending over at least 20 percent of the area of the diamond, while “a major portion” indicates coverage of at least about 50% of the area.

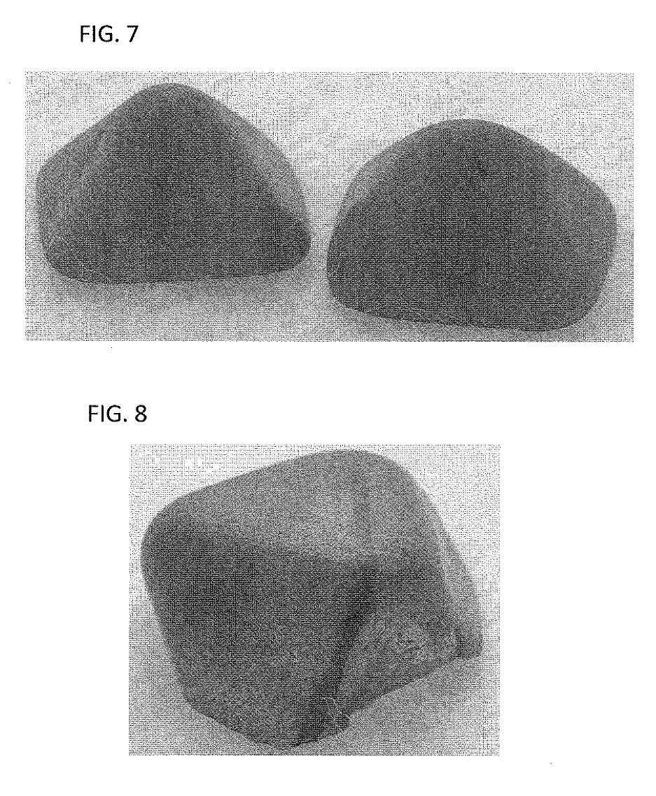

Turning now to the method of the present invention in more detail, the method starts by selecting a diamond having a visible cloud inclusion. As mentioned above, identification of potentially suitable diamonds in the raw state may be performed by one ordinarily skilled in the art by use of back lighting and/or by opening a small polished surface through the “skin” of the diamond to facilitate inspection. The invention may be applied to full octahedral crystal forms (e.g., like FIG. 7) as well as irregular or incomplete crystals (e.g., like FIG. 8). Diamonds having no visible cloud inclusions, or having inclusions which are only poorly visible or of unsuitable geometry, are sorted and removed for subsequent processing by conventional techniques as “brilliant cuts” of various types. In some cases, it may not be feasible to fully assess the potential of a cloud inclusion for forming a geometrical form until a table is formed. In such cases, a final or additional sorting step may be performed after sawing or cleaving of the diamond in order to decide which stones are most suited to processing according to the present invention and which would be more valuable processed with a conventional cut.

Once a diamond with a suitable visible cloud inclusion has been found, the diamond is cut and polished to form at least one crown facet and at least one pavilion facet, the crown and pavilion facets being angled so as to form a light transmission window over a readily noticeable portion of an area of the diamond. The provision of the light transmission window renders a geometrical form of the cloud inclusion readily visible to the unaided human eye.

The light transmission window may be implemented in many ways, as will be clear to one ordinarily skilled in the art. For example, a major part of either or both of the crown and pavilion may be formed as a shallow-angled pyramid with three, four or more primary facets, and optionally with a truncated culet or peak. Most preferably, however, the light transmission window is implemented primarily by providing a table and a major base facet substantially parallel to the table. In striking contrast to the minute culet facet of some brilliant cuts, the major base facet in this case preferably has an area greater than half the area of the table, and may typically be similar in size to the table. The table itself is preferably a very significant proportion of the area of the stone, typically corresponding to at least a fifth of the area of the diamond.

Other than the provision of the light transmission window, there are no limitations on the range of girdle shapes and facet arrangements which can be used to implement the present invention. Thus, the girdle of diamonds cut according to the present invention may be any desired girdle shape including, but not limited to, round, square, rectangular, octagonal, heart shaped, and pear shaped. Similarly, it should be noted that the remaining facets of the crown and pavilion may take any desired form. Thus, for example, the crown may be generally similar to any desired standard crown design where the table provides the required light transmission window. The pavilion may be a conventional pavilion structure truncated to form the required light transmission window, or may be a dedicated design formed directly without going through a pointed pavilion intermediate stage.

The cutting of diamonds according to the teachings of the present invention introduces numerous considerations which are distinctly different from the considerations of conventional diamond cutting. For example, referring to FIGS. 4A and 4B, there is shown schematically a raw diamond 10 in octahedral form with a visible cloud inclusion 12 located somewhat asymmetrically within the diamond. In order to maximize the aesthetic value of the geometrical form of the inclusion, the cutting and polishing is performed so as to render the geometrical form substantially centered relative to a cut girdle of the diamond. In other words, more is cut away from the left and rear portions of the diamond as viewed in order to ensure that the geometrical form is centrally placed in the cut diamond, as illustrated schematically in FIG. 4B. This clearly reduces the carat yield of the cut diamond significantly, thereby running directly against the primary consideration behind cutting decisions based on accepted conventions.

Similar considerations come into play regarding the choice of the plane of a table of the diamond. Where a symmetrical shape is sought, the table is preferably chosen relative to a shape of the cloud inclusion to render the geometrical form generally symmetrical as viewed through the table. In many cases, this is found to correspond to a four-corner-cut plane within the crystal, i.e., a plane parallel to the square belt of the octahedral crystal form. FIG. 7 illustrates a regular octahedral crystal cut along such a plane to form two separate similar stones. FIG. 8 illustrates a corresponding plane marked on an irregular shaped crystal for sawing. It should be noted that the sawing plane marked is chosen according to the teachings of the present invention in order to obtain a desired symmetrical form, and conflicts with the conventional teaching of maximizing carat yield which would directly employ the top surface as shown polished to form a table without subdivision of the stone.

Furthermore, according to a particularly preferred feature of certain implementations of the method of the present invention, the diamond is divided prior to polishing along a plane passing through the visible cloud inclusion so as to facilitate production of two smaller diamonds each including part of the visible cloud inclusion. This is illustrated in FIG. 4B where a common “table” for two diamonds is formed by cutting along plane 14 and a base facet for each diamond is formed by cutting along planes 16 and 18. This typically results in two closely matching polished stones, which may be appealing to a consumer as a unique matching pair. Here again, the added value of forming a pair of matching stones is given precedence over maximizing carat yield of the stone.

In certain cases, particularly where an inclusion is overly dark and thinning of the stone is necessary to increase the contrast, it may be advantageous to slice the stone along two or more parallel planes to generate a set of three or more stones with geometrical forms provided by different parts of the same cloud inclusion. It should be noted that the various slices do not necessarily need to be the same thickness.

In other cases, a stone may be subdivided into one or more stones containing all or most of the cloud inclusion, or a selected region of the inclusion, for forming into ornamental diamonds according to the teachings of the present invention, and one or more stones with lesser, or less suitable, cloud inclusion for cutting according to traditional techniques into a “brilliant” cut.

It will be appreciated that the above descriptions are intended only to serve as examples, and that many other embodiments are possible within the scope of the present invention as defined in the appended claims.

What is claimed is:

1. A method for processing diamonds comprising the steps of:
(a) selecting a diamond having a visible cloud inclusion;
(b) cutting and polishing said diamond to form a table and a major base facet substantially parallel to said table, thereby rendering a geometrical form of said cloud inclusion readily visible to the unaided human eye.

2. The method of claim 1, wherein said major base facet has an area greater than half the area of said table.

3. The method of claim 1, wherein said table has an area greater than a fifth of the area enclosed by a cut girdle of the diamond.

4. The method of claim 1, wherein a plane of said table is chosen relative to a shape of said cloud inclusion to render the geometrical form generally symmetrical as viewed through said table.

5. The method of claim 1, wherein said cutting and polishing is performed so as to render said geometrical form substantially centered relative to a cut girdle of the diamond.

6. The method of claim 1, wherein said geometrical form corresponds to a cross, and wherein said cutting and polishing is performed so as to render the center of said cross substantially centered relative to a cut girdle of the diamond.

7. The method of claim 1, wherein said table corresponds to a four-corner-cut plane.

8. The method of claim 1, wherein said cutting includes:
(a) dividing the diamond prior to polishing along a plane passing through the visible cloud inclusion so as to produce two smaller diamonds each including part of the visible cloud inclusion; and
(b) cutting and polishing each of the two smaller diamonds to form a table and a major base facet substantially parallel to said table.

9. The method of claim 1, wherein said cutting includes:
(a) dividing the diamond prior to polishing along at least two planes passing through the visible cloud inclusion so as to produce at least three smaller diamonds each including part of the visible cloud inclusion; and
(b) cutting and polishing each of the at least three smaller diamonds to form a table and a major base facet substantially parallel to said table.

10. A method of processing a plurality of diamonds comprising the steps of:
(a) selecting diamonds having a cloud enclosure;
(b) cutting said diamonds to form a table;
(c) sorting to identity cloud enclosures having one or more desired geometrical form; and
(d) cutting and polishing diamonds having the desired geometrical form to form a major base facet substantially parallel to said table, thereby rendering the geometrical form of said cloud inclusion readily visible to the unaided human eye.

11. The method of claim 10, further comprising cutting and polishing the diamonds not having the desired geometrical form according to a brilliant cut.

12. An ornamental diamond formed from a natural diamond having a visible cloud inclusion, the diamond being cut and polished to exhibit:
(a) a table; and
(b) a major base facet substantially parallel to, and in facing relation to, said table, said major base facet having an area greater than half the area of said table, thereby rendering a geometrical form of the cloud inclusion readily visible to the unaided human eye.

13. The ornamental diamond of claim 12, wherein the diamond further exhibits a girdle, and wherein said table has an area greater than a fifth of the area enclosed by said girdle of the diamond.

14. The ornamental diamond of claim 12, wherein a plane of said table is chosen relative to a shape of the cloud inclusion so that the geometrical form is generally symmetrical as viewed through said table.

15. The ornamental diamond of claim 12, wherein the geometrical form is substantially centered relative to a girdle of the diamond.

16. The ornamental diamond of claim 12, wherein said geometrical form corresponds to a cross.

17. The ornamental diamond of claim 12, wherein said table corresponds to a four-corner-cut plane.

18. A pair of ornamental diamonds each according to claim 12, wherein said pair of ornamental diamonds include a pair of cloud inclusions providing similar geometrical forms generated by cutting a single raw unpolished diamond on a plane subdividing a cloud inclusion.

19. A method for processing diamonds comprising the steps of:
(a) selecting a diamond having a visible cloud inclusion;
(b) cutting and polishing said diamond to form at least one crown facet and at least one pavilion facet, said crown and pavilion facets being angled so as to form a light transmission window over a readily noticeable portion of an area of the diamond, thereby rendering a geometrical form of said cloud inclusion readily visible to the unaided human eye.

20. The method of claim 19, wherein a major part of said light transmission window is formed by a primary table facet of said crown and a primary base facet of said pavilion angled relative to said primary table facet at an angle of no more than about 20 degrees.

21. The method of claim 19, wherein a major part of said light transmission window is formed by a primary table facet of said crown and a primary base facet of said pavilion substantially parallel to said primary table facet.
